(19) United States
(12) Patent Application Publication
(10) Pub. No.: US 2020/0008912 A1
(43) Pub. Date: Jan. 9, 2020

(54) DENTAL POLISHING CUPS MADE FROM ABRASIVE POLYMERIC SPONGES

(71) Applicant: CAO Group, Inc., West Jordan, UT (US)

(72) Inventor: Steven D. Jensen, West Jordan, UT (US)

(21) Appl. No.: 16/489,443

(22) PCT Filed: Feb. 28, 2018
(86) PCT No.: PCT/US18/20223

§ 371 Date: Aug. 28, 2019

Related U.S. Application Data
(60) Provisional application No. 62/465,495, filed on Mar. 1, 2017.

(51) Int. Cl. A61C 17/00; A61C 17/22

(52) U.S. Cl. CPC A61C 17/005; A61C 17/22

(57) ABSTRACT

A dental polishing tool may comprise a polishing cup comprising an abrasive polymeric sponge.

### CROSS-REFERENCES TO RELATED APPLICATIONS

This application claims the benefit of PCT Application No. PCT/US2018/020223, filed Feb. 28, 2018, which is a non-provisional of U.S. Provisional Application No. 62/465,495 filed on Mar. 1, 2017, each of which is hereby incorporated by reference in its entirety.

### TECHNICAL FIELD OF THE INVENTION

The present invention discloses dental polishing cups made from abrasive polymeric sponges.

### SUMMARY

The invention discloses dental polishing cups made from abrasive polymeric sponges.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 depicts a cross-sectional view of a dental handpiece including a dental polishing cup made from abrasive polymeric sponge according an embodiment of the present invention.

### DETAILED DESCRIPTION OF THE INVENTION

Polishing cups are a standard item utilized by dentists usually to remove stains and polish surfaces. These cups are usually made from rubber or elastomeric polymer. The cups are designed to be disposable. They are usually fitted onto a metal shank and inserted into a low speed hand-piece or they are assembled into a plastic disposable angle and inserted onto a low speed hand-piece. The cups are usually filled with various types of abrasive pastes and liquids. Abrasives such as diamond powder, silicon carbide, silica, pumice, aluminum oxide, and many other abrasives are utilized for specific treatments. Polishing cups are used in polishing: composites, porcelain, and teeth. They are also used to remove extrinsic stains such as in a prophylaxis paste. The downside to these abrasive pastes is that they tend to flip out or spin out during cleaning treatments. The abrasive pastes just don't stay in the cup for long and therefore needs be replaced often. The biggest disadvantage to abrasive pastes is they fill up the vacuum systems over time. Spent abrasive paste must be removed from the oral cavity by suction and the abrasive paste is now separated from its emulsifier. The abrasive grains act similar to sand and water and quickly settle to the bottom; these collect in the vacuum pumps and eventually clog lines and cause problems down the road. What is needed are polishing/prophy cups with the abrasive contained within the cup itself. A further improvement would be that the entire cup is absorbent such that is capable of absorbing a liquid component that is designed to act as a lubricant, active ingredient delivery vehicle, and surfactants/surface active agents.

Embodiments of the present invention are centered on an abrasive sponge. The abrasive component can be an integral part of the polymer itself, or it can be added as part of a secondary step in the manufacture. The preferred sponge is a sponge wherein the polymer itself comprises both the sponge material and the abrasive as an integral part of the polymer itself. The preferred material is melamine polymer. Melamine sponge forms an open cell that is microporous. Its open cell structure is an array of tight interconnected bubbles in a maze of fibrous polymer strands. Melamine polymer is a very hard polymer wherein the fiber strands continue to maintain this hardness even when manufactured into a sponge. On a large scale the melamine foam feels soft to the touch, but at a finer scale it is likened to sandpaper. A melamine sponge is capable of removing extrinsic stains from various dental surfaces such as teeth, porcelain and composite. It is also an ideal polishing agent for the final polish as comparable to fine grit.

The melamine sponge is then molded into a standard prophy or polishing cup that is friction fitted or adhered to the metal or plastic driving post. The outer surface of the sponge not including the cup is then coated in water insoluble elastomeric coating. The coating provides a barrier for the treatment liquid/gel such that it stays contained within the cup. The dental professional need only apply the treatment liquid/gel into the cup wherein it is quickly absorbed or retained within the cup. This is then pressed against the object to be polished or cleaned and the low speed hand-piece is activated and allowed to rotate such that the abrasion from the melamine sponge is allowed to function.

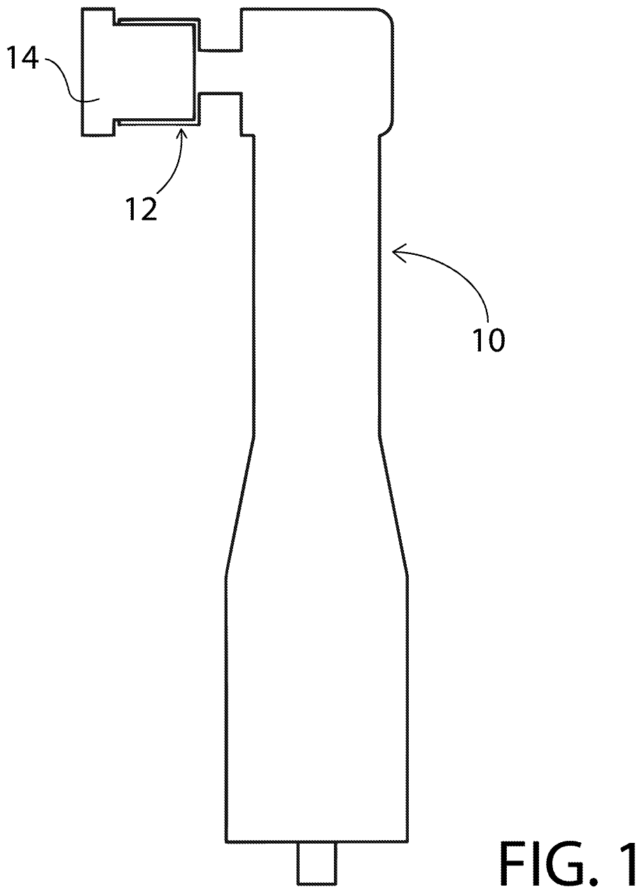

Embodiments of the present invention also utilizes a new prophylaxis cup design and a liquid solution that is intended to lubricate the tooth surface during operation. As shown in FIG. 1, a metal or plastic shank that is inserted into a re-usable low-speed hand piece 10 or the shank can be permanently attached to a disposable prophy cup head 12. An abrasive elastomeric cup 14 made of an abrasive polymeric sponge material may be positioned within the prophy cup head 12, wherein the abrasive substance and sizes can be varied such that different grits of fineness can be achieved—such as coarse, medium and fine grits. The abrasive sponge material of the cup 14 may absorb a new prophy solution and release said solution when the cup 14 is pressed against the teeth. The prophy solution acts as a lubricant, surfactant, and a medicament delivery medium. In some embodiments, the imbedded abrasive grit is disseminated within the elastomeric cup 14. In additional embodiments, grit may be imbedded onto the surface of the cup 14 to form a surface similar to sandpaper.

The cup 14 design can be of various shapes, angles and sizes such that optimum exposure to teeth surfaces can be achieved. The preferred shape is the conventional prophy cup that dental professionals are accustomed to. The cup 14 is ideally made from an elastomeric polymer similar in properties as flexible rubber. The elastomeric cup 14 is intended to flex substantially to conform to the tooth surface when gently pressed against the teeth. The ends of the cup 14 are designed to clean between the teeth during rotation. The elastomer cup 14 can be made from various materials such as natural rubber, neoprene, PVC, poly butadiene, poly isoprene, polyacrylic rubber, polysulfide rubber, resilin, gutta percha, chlorsulfonated polyethylene, fluorosilicone rubber, polyurethane rubber, polysulfide rubber, and any other useful elastomer and/or elastomeric copolymer.

An absorbant material may be adhered/friction fitted into the center of the cup 14 as a delivery device for the liquid prophy solution. The sponge or absorbent material can be made from natural sponge material like cellulose sponge, cellulose fiber, luffa and polymeric sponges like polyurethane foam, PVA foam, polyether foam, polyester foam, and any useful absorbent material.

The elastomer of the present invention may be filled with various grit materials and combinations of grit materials to achieve a specific degree of abrasiveness. The abrasive may be placed into the elastomeric cup 14 itself with the intention of removing the grit from a thick sloppy paste. Various grit sizes or meshes can be selected to impart a specific abrasiveness or property to the cup. The grit can be selected from powdered materials such as Silica, glass, mica, pumice, aluminum oxide, diamond, silicone nitride, boron nitride, and any other useful abrasive. The abrasive/grit is simply blended with the elastomer at time of manufacture. The grit can be simply blended with a thermoplastic prior to molding or blended with a thermoset plastic prior to permanently setting into a pre-molded shape. The grit can also be inserted onto the cup surface to leave a surface similar to sandpaper; the grit can be heated sufficiently that they imbed themselves into the cup. Various techniques can be utilized to imbed the grit/abrasive into the elastomer prior to molding.

The liquid prophy solution performs various functions such as a lubricant between the tooth surface and the abrasive cup, a surfactant and solvent to aid in water insoluble stain removal, and a medicament delivery medium such as a mean to deliver fluoride to the teeth surface during the cleaning. The lubricant and solvent can be selected from a group of similar materials such as liquid polyethylene glycol, glycerin, water, propylene glycol, ethanol, silicone oil, vitamin D, and any other useful surface lubricant and solvent. Surfactants can be selected from any surface stain removing compound such as sodium lauryl sulfate, Polysorbates, Lauryl dimethyl amine oxide, Cetyltrimethylammonium bromide, Polyethoxylated alcohols, Polyoxyethylene sorbitan, Octoxynol, N,N-dimethyldodecylamine-N-oxide, Hexadecyltrimethylammonium bromide, Polyoxyl 10 lauryl ether, Brij, Polyoxyl castor oil, Nonylphenol ethoxylate, Cyclodextrins, Lecithin, Methylbenzethonium chloride and any other useful surface active agent.

The composition can contain useful medicament such as sodium fluoride, calcium citrate, ascorbic acid, potassium fluoride, potassium nitrate, stannous fluoride, sodium carbonate, and any other useful medicament. The medicament is intended to beneficially aid the tooth in reducing common ailments such as tooth sensitivity, cavities, and other ailments.

### Liquid Prophy Composition #1:

1. 25%—water

2. 1%—sodium lauryl sulfate

3. 74%—glycerin

### Liquid Prophy Composition #2:

1. 25%—water

2. 1%—Lauryl dimethyl amine oxide

3. 74%—propylene glycol

### Liquid Prophy Composition #3:

1. 25%—water

2. 75%—polyethylene glycol 300

### Liquid Prophy Composition #4:

1. 25%—ethanol

2. 1%—Polyoxyl castor oil

3. 74%—glycerin

### Liquid Prophy Composition #5:

1. 100%—glycerin

Optionally the compositions of the present invention can contain flavors, colors, and sweeteners. The preferred colors are D&C and FD&C dyes. Flavors can be selected from customary flavors such as peppermint oil, spearmint oil, orange oil, berry flavor, root beer, and any other flavor. Sweeteners such as phenylalanine, sodium saccharin, sucralose and any other useful sweetener can be optionally added for increased patient comfort.

What is claimed is:

1. A dental polishing tool comprising:
a cup comprising an abrasive polymeric sponge.
